(19) United States
(12) Patent Application Publication
(10) Pub. No.: US 2007/0182327 A1
(43) Pub. Date: Aug. 9, 2007

(54) MANUFACTURING METHOD OF ELECTRODE FOR ATMOSPHERIC PRESSURE PLASMA, ELECTRODE STRUCTURE, AND ATMOSPHERIC PRESSURE PLASMA APPARATUS USING THE SAME

(75) Inventors: Tae Wook KIM, Seoul (KR); Kyung Ho Ryu, Ansong-shi (KR)

Correspondence Address: DITTHAVONG MORI & STEINER, P.C., 918 Prince St., Alexandria, VA, 22314, US

(73) Assignee: K.C. Tech Co., LTD., Ansong-Shi (KR)

(21) Appl. No.: 11/466,203

(22) Filed: Aug. 22, 2006

(30) Foreign Application Priority Data
Aug. 22, 2005 (KR) 10-2005-0076654

(51) Int. Cl. H01J 17/49

(52) U.S. Cl. 313/582

(57) ABSTRACT

Disclosed are a method of manufacturing an electrode for generating plasma, which is capable of improving durability of the electrode and reducing production costs of the electrode, an electrode structure, and an atmospheric pressure plasma apparatus using the same. The plasma electrode structure comprises a pair of electrodes isolated from each other, a plasma generating space formed between the pair of electrodes, and an oxide coating layer formed uniformly on at least one of surfaces of the pair of electrodes.

### CROSS-REFERENCE TO RELATED APPLICATION

This application claims priority under 35 U.S.C. § 119 to Republic of Korea patent application No. 10-2005-0076654 filed Aug. 22, 2005, the entire contents of which are incorporated herein by reference thereto.

### FIELD OF THE INVENTION

The present invention relates to a method of manufacturing an electrode for generating plasma through a discharge under an atmospheric pressure, an electrode structure, and an atmospheric pressure plasma apparatus using the same.

### DESCRIPTION OF THE RELATED ART

Of FPD (Flat Panel Display) surface treatment apparatuses, an atmospheric pressure plasma apparatus is being increasingly used because it can be implemented as an in-line system without requiring a separate chamber or vacuum system.

An existing plasma apparatus needs an expensive vacuum chamber and a system requiring a high treatment speed and high-priced equipment and maintenance. Recently, as a substitution for the existing plasma apparatus, the atmospheric pressure plasma apparatus has been actively developed and applied to various plasma processes.

FIG. 1 is a schematic view showing a configuration of a cleaning system 100 using a general atmospheric pressure plasma apparatus.

As shown in FIG. 1, a cleaning system 100 includes an atmospheric pressure plasma apparatus 110 for jetting oxygen radicals 107, which are generated by a plasma reaction, on a surface of an LCD glass 130 to be cleaned, a power supply 140 for applying an alternating voltage to the atmospheric pressure plasma apparatus 110, a gas supplying apparatus 120 for supplying gases such as nitrogen, oxygen, air and the like to the atmospheric pressure plasma apparatus through a gas pipe, and a conveyer 160 for conveying the LCD glass 130 at a constant speed in a specific direction while the atmospheric pressure plasma apparatus performs an atmospheric pressure plasma discharge.

A treatment gas supplied from the gas supplying apparatus 120 is introduced into a barrier dielectric space 105 of the atmospheric pressure plasma apparatus 110 through a gas inlet 108. Before the introduction, the amount of flow of the supplied gas is controlled by a mass flow controller (MFC) 121.

On an upper portion of the atmospheric pressure plasma apparatus 110 is disposed a gas distributor 109 for uniformly distributing the treatment gas supplied through the gas inlet 108 inside the barrier dielectric space 105.

On a lower portion of the gas distributor 109 are provided a first dielectric 101 and a second dielectric 102 for generating a plasma through dielectric charging and discharging.

In addition, a power electrode 104 is formed on the first dielectric 101 and a ground electrode 103 is formed on the second dielectric 102 to apply an alternating voltage to the first and second dielectrics 101 and 102. In this case, as shown in FIG. 1, the first and second dielectrics 101 and 102 face each other vertically, that is, is of a vertically parallel-facing DBD (Dielectric Barrier Discharge) type.

In addition, the power electrode 104 on the first dielectric 101 is connected to the power supply 140 and the ground electrode 103 on the second dielectric 102 is grounded.

In addition, on the power electrode 104 and the ground electrode 103 is installed a heat sink 111 to cool heated electrodes.

A cleaning process of the cleaning system 100 will be now described.

The conveyer 160 provided below the LCD glass 130 conveys the LCD glass 130 to be cleaned at a constant speed in a specific direction. At this time, when the alternating voltage is applied to the power electrode 104 provided on the first dielectric 101, the gas introduced into the barrier dielectric space 105 raises a plasma reaction, and the oxygen radicals 107 generated by the plasma reaction are discharged outside the atmospheric pressure plasma apparatus 110 through a gas outlet 106.

The discharged oxygen radicals 107 are jetted on a surface of the LCD glass 130 to be cleaned, while removing organic substances from the surface of the LCD glass 130.

In this manner, in the atmospheric pressure plasma cleaning method in which the plasma is generated under the atmosphere pressure, contaminants such as residual polymers produced during manufacture of a circuit, as well as organic substances on a surface of a substrate, are removed using the oxygen radicals in the plasma, thereby providing a high cleaning efficiency environmentally-friendly and stably.

Typically, the atmospheric pressure plasma apparatus 110 employs a DBD-typed electrode structure where electrodes face each other vertically or horizontally in parallel.

FIGS. 2a to 2c are views showing a conventional horizontally-parallel facing typed plasma electrode structure 200.

As shown in FIGS. 2a to 2c, the plasma electrode structure 200 includes a first dielectric 210 and a second dielectric 220, which face each other in parallel.

In addition, a precisely-machined insulating spacer or other gap adjustment tools may be used to keep a gap between the first dielectric 210 and the second dielectric 220 constant.

Herein, typically, the first and second dielectrics 210 and 220 mainly comprise ceramic having a high dielectric constant, for example, silicon dioxide, aluminum oxide, zirconium dioxide, titanium dioxide, yttrium oxide, etc.

In addition, a power electrode 211 and a ground electrode 221 to which a high voltage is applied are formed at sides in the opposite of facing sides of the first and second dielectrics 210 and 220. Here, the power electrode 211 and the ground electrode 221 comprise a metal thin film. A process of forming the metal thin film will be described below.

A pasted good conductor such as silver, gold, aluminum or the like is coated on the surfaces of the first and second dielectrics 210 and 220 using a screen printing method, a spray coating method or the like, and then is sintered at a high temperature. Thereafter, the sintered conductor is crystallized into a metal thin film to be completely adhered to the first and second dielectrics 210 and 220. This is for making electrodes without any defects such as bubbles when the first and second dielectrics 210 and 220 are combined with the metal thin film.

The reason for making electrodes without any defects is that, if there exist bubbles between the dielectrics and the electrodes, a plasma is generated from the bubbles, thereby generating much heat, and the generated heat deteriorates insulating properties of the dielectrics, which results in breakdown of the dielectrics, i.e., “arcing.”

After the metal thin film-shaped electrodes 211 and 221 are formed on sides of the first and second dielectrics 210 and 220, respectively, first and second protective films 214 and 224 have to be coated on the metal thin film to protect the metal thin film. This is because metal has very low resistance to activated molecules, which may be generated by plasma.

The first and second protective films 214 and 224 comprise polymer plastics or inorganic materials of ceramic base having high resistance to plasma. A coating method depends on a material used.

In addition, on the first dielectric 210 are formed gas inlets 212 and 213 through which a treatment gas such as nitrogen, argon, helium, oxygen or the like is introduced into a barrier dielectric space 230 between the power electrode 211 and the ground electrode 221.

In addition, when an alternating voltage is applied to the power electrode 211, the treatment gas introduced into the barrier dielectric space 230 is excited by a plasma reaction. At this time, one or more fine hole or slit-shaped gas outlets 223 through which the excited treatment gas (positive ions, electrons, radicals, etc.) is jetted on an object to be treated (glass, semiconductor wafer, etc.) are formed through the second dielectric 220, the ground electrode 221 and the second protective film 224.

In this manner, the plasma electrode structure generates the plasma between a pair of opposite dielectric electrodes according to the DBD method. Thereafter, the treatment gas excited by the plasma is discharged through gas outlets formed on one of the pair of dielectric electrodes, and the object placed below the one dielectric electrode is treated by the discharged treatment gas.

FIG. 2c is an enlarged view of the second dielectric electrode (indicated by an oblique line) on which the gas outlets 223 are formed in the electrode structure shown in FIG. 2b.

As shown in FIG. 2c, a very thin metal electrode (the ground electrode) 221 is covered by the protective film 224 in view of a section of the gas outlets 223.

In this condition, when a DUD discharging is generated, electric charges having different polarities are collected on upper and lower portions of the second dielectric 220. Then, an electric field is produced between the upper and lower portions of the second dielectric 220. Particularly, at an edge of the thin metal electrode 221 is produced a strong electric field due to an edge effect.

The produced electric field causes a breakdown effect in an air layer at upper and lower surfaces of the second dielectric 220. In other words, a kind of surface discharging is generated along a wall of the second dielectric 220 between the upper surface of the second dielectric 220 and the edge of the ground electrode 221.

The generated surface discharging may damage a surface of an electrode where a discharging is generated by activated ions having high energy. In particular, the surface discharging heavily damages the second protective film 224 at a relatively thin electrode edge.

FIGS. 3a and 3b are views showing examples of the surface discharging generated at a portion indicated by the oblique line in FIG. 2b.

FIG. 3a shows an initial state where a ceramic dielectric, a metal thin film and a ceramic protective film are coated in order, and FIG. 3b shows damages to a protective film and an electrode around circles (gas outlets) by a surface discharging generated after a lapse of 100 hours after the initial coating.

In this manner, if a discharging having concentrated energy continues to be generated, even a material having a plasma-resistance may be damaged by such a direct continuous discharging.

Moreover, if the second protective film 224 is damaged by the surface discharging, the ground electrode 221 may be directly exposed to the surface discharging. Accordingly, metal electrodes having no plasma-resistance may be quickly damaged and come to the end of its durability.

Although such damage may be prevented by making the second protective film 224 thick sufficiently, this method is not easy to be conducted. Methods of coating inorganic matter of ceramic series or polymer compounds may include a plasma spaying method, an arc spraying method, a sol-gel method in which pasted materials are spray-coated or screen-printed and then sintered, etc. However, there is a limitation on increase of the thickness of an edge cut at a right angle, like the ground electrode 221.

In addition, although it is possible to increase the thickness of the second protective film 224 at a surface of the flat ground electrode 221, it is difficult to increase an internal thickness of a section of the gas outlets 223.

In addition, even when the thickness of the protective film at the edge is increased, risk of generation of a surface discharging by an electric field effect is still in existence.

Accordingly, there remains a problem that erosion of the protective film is accelerated due to the surface discharging and the electrodes are directly exposed to the surface discharging, which results in rapid deterioration of the durability of the electrodes.

### SUMMARY OF THE INVENTION

To overcome the above problems, the present invention relates to providing a manufacturing method of an electrode for atmospheric pressure plasma, which is capable of forming an oxide coating layer functioning as both of a dielectric and a protective layer on an electrode, an electrode structure, and an atmospheric pressure plasma apparatus using the same.

The foregoing can be achieved by providing a plasma electrode structure comprising a pair of electrodes isolated from each other; a plasma generating space formed between the pair of electrodes; and an oxide coating layer formed uniformly on at least one of surfaces of the pair of electrodes.

Preferably, the electrodes comprise an alloy on a surface of which an oxide coating film can be naturally or artificially formed.

Preferably, the electrodes comprise one of aluminum, titanium, magnesium, zinc and tantalum alloys.

Preferably, the oxide coating layer comprises one of an aluminum oxide, a titanium oxide, a magnesium oxide, a zinc oxide and a tantalum oxide.

Preferably, the oxide coating layer is formed using an anodizing method.

The foregoing can be also achieved by providing an atmospheric pressure plasma apparatus comprising a plasma electrode structure including a pair of electrodes isolated from each other and an oxide coating layer formed uniformly on at least one of surfaces of the pair of electrodes, wherein a gas introduced into a plasma generating space formed between the pair of electrodes is plasma-discharged, and gas ions generated by the plasma discharging are jetted on an object to be treated.

The foregoing can be also achieved by providing a method of manufacturing an electrode for atmospheric pressure plasma, wherein the electrode is formed using metal, and an oxide coating layer is uniformly formed on the entire surface of the electrode.

Preferably, the oxide coating layer is formed using an anodizing method.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a schematic view showing a configuration of a cleaning system using a general atmospheric pressure plasma apparatus;

FIGS. 2a to 2c are views showing a conventional horizontally-parallel facing typed plasma electrode structure;

FIGS. 3a and 3b are views showing examples of a surface discharging in the conventional plasma electrode structure;

FIGS. 4a and 4b are views showing a plasma electrode structure according to a preferred embodiment of the present invention; and

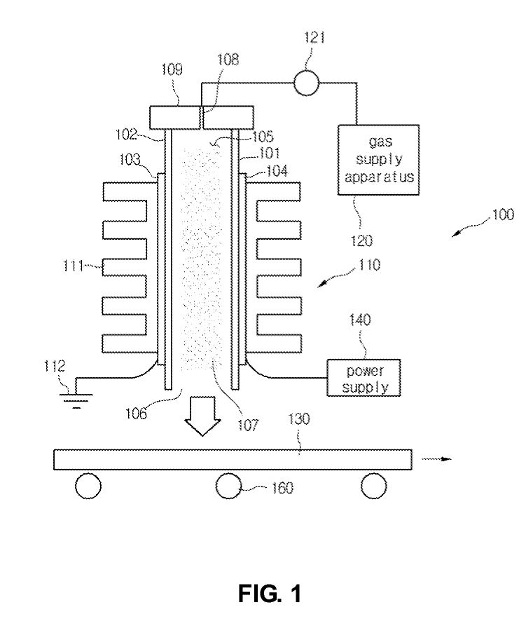

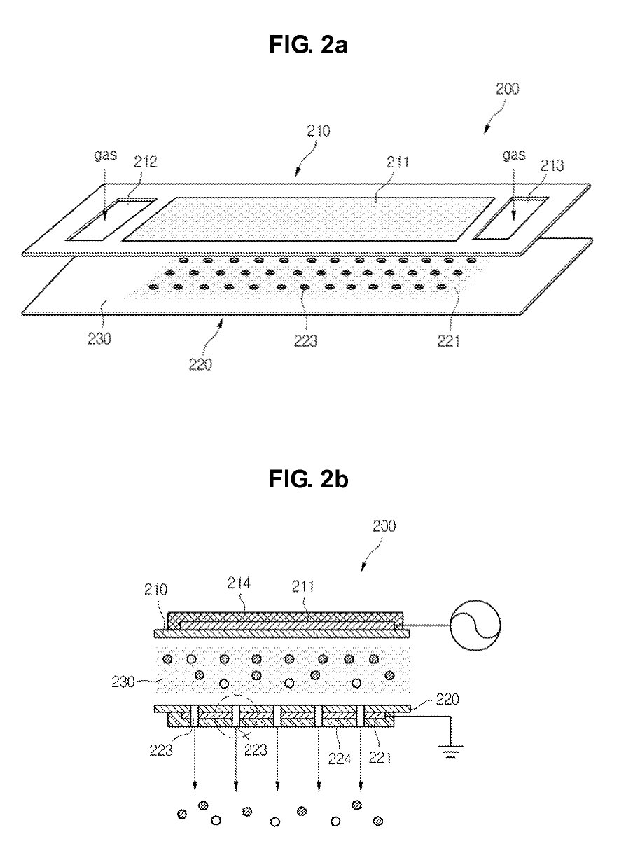

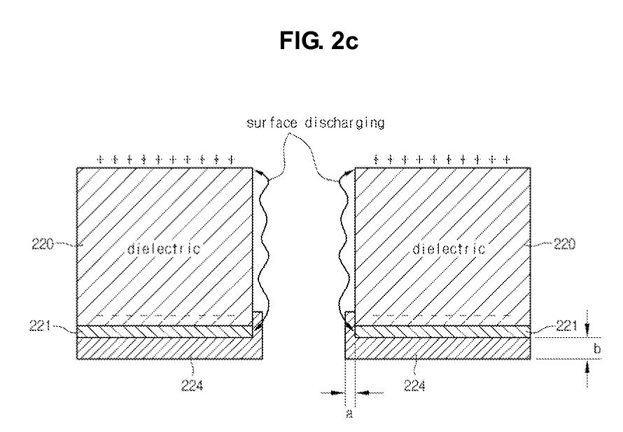

is FIGS. 5a and 5b are views showing that a surface discharging is not generated in the plasma electrode structure according to the preferred embodiment of the present invention.

### DETAILED DESCRIPTION OF THE PREFERRED EMBODIMENTS

Reference will now be made in detail to exemplary embodiments of the present invention, examples of which are illustrated in the accompanying drawings.

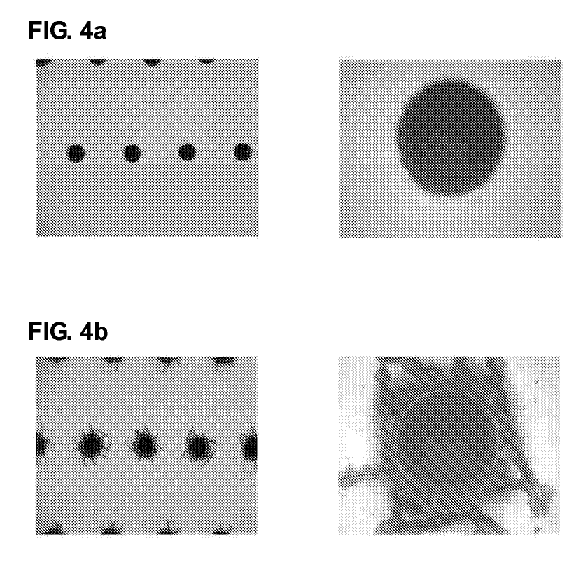

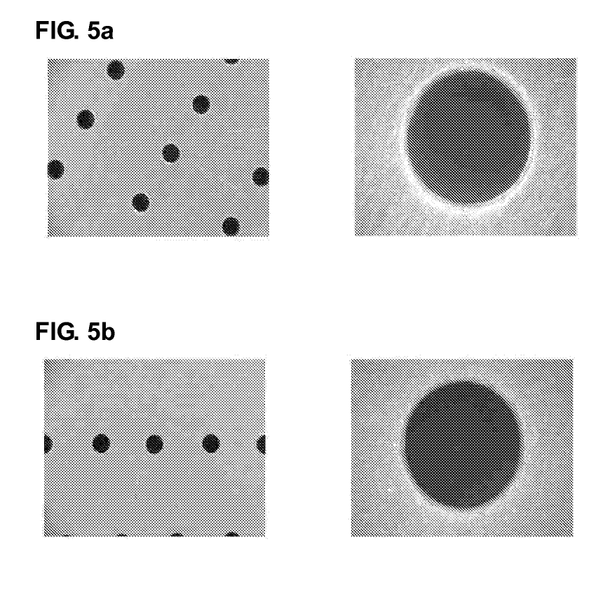

FIGS. 4a and 4b are views showing a plasma electrode structure 300 according to a preferred embodiment of the present invention.

As shown in FIG. 4a, a plasma electrode structure 300 according to the preferred embodiment of the present invention includes a flat power electrode 311 and a flat ground electrode 321, which face each other in parallel, for applying a high frequency voltage for plasma generation.

In addition, oxide coating layers 310 and 320 are uniformly formed on the entire surfaces of the power electrode 311 and the ground electrode 321, respectively, and a plasma generation space 330 is formed between the power electrode 311 and the ground electrode 321.

In addition, a gas inlet (not shown) through which a treatment gas is introduced into the plasma generation space 330 to generate plasma may be formed in one of the electrodes or a lateral side of the plasma generation space 330.

When an alternating voltage is applied to the power electrode 311, the treatment gas introduced into the plasma generation space 330 is excited by a plasma reaction. At this time, one or more fine hole or slit-shaped gas outlets 323 through which the excited treatment gas (positive ions, electrons, radicals, etc.) is jetted on an object to be treated (glass, semiconductor wafer, etc.) are formed through the ground electrode 321 and the oxide coating layer 320.

In the conventional plasma electrode structure as described earlier, a dielectric barrier is formed using ceramic, a thin film metal electrode is formed on a surface of the dielectric barrier, and a protective film is formed on the thin film metal electrode.

However, in the present invention, the power electrode 311 and the ground electrode 321 are formed, and then the plurality of gas outlets 323 passing through the ground electrode 321 are formed

Thereafter, the oxide coating layers 310 and 320 are formed on the entire surfaces of both electrodes 311 and 321 using an anodizing method.

In addition, although it is shown in FIG. 4a that the oxide coating layers 310 and 320 are formed on both electrodes 311 and 321, an oxide coating layer may be formed on one of the electrodes 311 and 321, particularly, on only the ground electrode 321 where a surface discharging is generated in an inner side of the gas outlets 323.

In addition, the power electrode 311 and the ground electrode 321 may mainly comprise an aluminum (Al) alloy, or other alloys including, for example, titanium (Ti), magnesium (Mg), Zinc (Zn), tantalum (Ta) alloys, etc., capable of forming an oxide coating layer on these electrodes 311 and 321 naturally or artificially.

In addition, the oxide coating layers 310 and 320 formed by the anodizing method comprise an aluminum oxide (Al₂O₃) crystal, which is referred to as an alumina used typically as a dielectric of a DBD electrode, or other oxides including, for example, titanium oxide (TiO₂), magnesium oxide (MgO), Zinc oxide (ZnO), tantalum oxide (Ta₂O₅), etc.

Accordingly, the oxide coating layers 310 and 320 can function as not only a dielectric, but also a protective film for protecting the power electrode 311 and the ground electrode 321 comprising the aluminum alloy, without requiring a separate protective film because of excellent corrosion-resistance and plasma-resistance of the oxide coating layers 310 and 320.

In addition, since the anodizing method forms the oxide coating layers 310 and 320 on the entire surfaces of the electrodes 311 and 321 comprising the aluminum ally by digesting the electrodes 311 and 321 into an electrolyte and using an electrolysis, the oxide coating layers 310 and 320 can be uniformly formed on the entire surfaces of the electrodes 311 and 321 even if these electrodes 311 and 321 have a very complex shape.

That is, the oxide coating layers 310 and 320 can be formed at the same thickness over a range from flat portions of the electrodes 311 and 321 up to the internal side of the gas outlets.

In addition, although it is illustrated in this embodiment that the electrodes 311 and 321 comprise the aluminum alloy, the electrodes 311 and 321 may comprise various different metal alloys capable of forming the oxide S coating layers 310 and 320 using the anodizing method

In addition, the oxide coating layers 310 and 320 may also comprise metallic oxides other than the aluminum oxide.

FIG. 4b is an enlarged view of the oxide coating layer 320 and the ground electrode 321 (indicated by an oblique line) on which the gas outlets 323 are formed in the electrode structure shown in FIG. 4a.

As shown in FIG. 4b, at the time of DBD discharging, electric charges are collected on a surface of the oxide coating layer 320 and a base layer, thereby producing an electric field. However, an electric field can not be produced through an air layer by the oxide coating layer 320 formed uniformly on the entire surface of the ground electrode 321.

In addition, since the ground electrode 321 comprises the aluminum alloy of a bulk state (1 to 5 mm), not a metal thin film shape (4 to 20 μm), an electric field effect at an edge as in the metal thin film does not occur, and moreover, electric charges are not concentrated on a particular portion of the ground electrode 321.

For this reason, a surface discharging can be reliably prevented from being generated at the surface of the ground electrode 321.

FIGS. 5a and 5b are views showing that a surface discharging is not generated in the plasma electrode structure according to the preferred embodiment of the present invention.

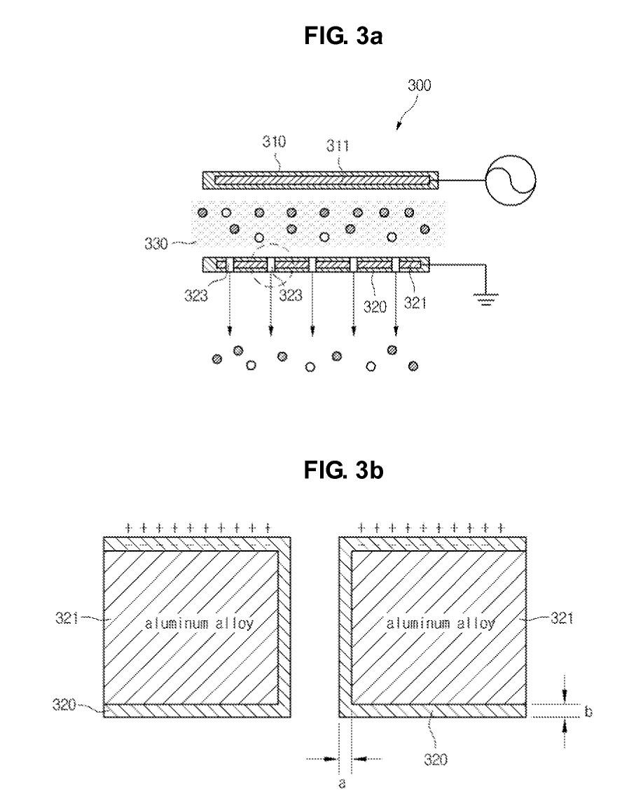

FIG. 5a shows an initial state of forming the plasma electrode structure according to the embodiment of the present invention, and FIG. 5b shows the same initial state as FIG. 5a, without doing any damages to the oxide coating layers 310 and 320 and the electrodes 311 and 321 around circles (gas outlets) after a plasma discharging lasts for 100 hours, unlike the conventional method (see FIG. 3b).

In this manner, when a surface discharging is not generated, since damages due to collision between ions having high energy are not done to the oxide coating layers 310 and 320 and the electrodes 311 and 321, the oxide coating layers 310 and 320 and the electrodes 311 and 321 can be even much prolonged in their durability over the existing protective film.

As described above, the plasma electrode structure according to the embodiment of the present invention can be used as an electrode structure in various kinds of plasma discharging apparatuses as well as the atmospheric pressure plasma apparatus.

As apparent from the above description, the present invention provides a manufacturing method of an electrode for atmospheric pressure plasma, which is capable of forming an oxide coating layer functioning as both of a dielectric and a protective layer on an electrode, an electrode structure, and an atmospheric pressure plasma apparatus using the same.

More specifically, by forming the electrode using a relatively inexpensive aluminum alloy instead of a expensive ceramic dielectric and forming a protective film on a surface of the electrode using an anodizing method, a process of forming metal thin film on the surface of the electrode and a process of coating a protective film on the metal thin film can be eliminated, which results in simplification of a process of manufacturing the electrode as well as significant reduction of production costs.

Furthermore, since an oxide coating layer comprises an aluminum alloy of a bulk state and is formed at a uniform thickness using an anodizing method, generation of a surface discharging can be prevented, which results in improvement of electrode durability.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A plasma electrode structure comprising:
a pair of electrodes isolated from each other;
a plasma generating space formed between the pair of electrodes; and
an oxide coating layer formed uniformly on a surface of at least one of the electrodes.

2. The plasma electrode structure according to claim 1, wherein the electrodes comprise an alloy on a surface of which an oxide coating film can be naturally or artificially formed.

3. The plasma electrode structure according to claim 2, wherein the oxide coating layer comprises an oxide selected from the group consisting of an aluminum oxide, a titanium oxide, a magnesium oxide, a zinc oxide, and a tantalum oxide.

4. The plasma electrode structure according to claim 3, wherein the oxide coating layer is formed using an anodizing method.

5. The plasma electrode structure according to claim 1, wherein the electrodes comprise an alloy selected from the group consisting of aluminum alloy, titanium alloy, magnesium alloy, zinc alloy, and tantalum alloy.

6. The plasma electrode structure according to claim 5, wherein the oxide coating layer comprises an oxide selected from the group consisting of an aluminum oxide, a titanium oxide, a magnesium oxide, a zinc oxide, and a tantalum oxide.

7. The plasma electrode structure according to claim 6, wherein the oxide coating layer is formed using an anodizing method.

8. The plasma electrode structure according to claim 1, wherein the oxide coating layer comprises an oxide selected from the group consisting of an aluminum oxide, a titanium oxide, a magnesium oxide, a zinc oxide, and a tantalum oxide.

9. The plasma electrode structure according to claim 8, wherein the oxide coating layer is formed using an anodizing method.

10. An atmospheric pressure plasma apparatus comprising:
a plasma electrode structure including a pair of electrodes isolated from each other and an oxide coating layer formed uniformly on a surface of at least one of the pair of electrodes,
wherein a gas introduced into a plasma generating space formed between the pair of electrodes is plasma-discharged, and gas ions generated by the plasma discharging are jetted on an object to be treated.

11. A method of manufacturing an electrode for atmospheric pressure plasma, wherein the electrode is formed using metal, and an oxide coating layer is uniformly formed on the entire surface of the electrode.

12. The method according to claim 11, wherein the oxide coating layer is formed using an anodizing method.
